(19) United States
(12) Patent Application Publication
(10) Pub. No.: US 2016/0077907 A1
(43) Pub. Date: Mar. 17, 2016

(54) NETWORK PROCESSING TRACING DEVICE, NETWORK PROCESSING TRACING METHOD, AND STORAGE MEDIUM

(71) Applicant: NEC Corporation, Tokyo (JP)

(72) Inventor: Atsushi TSUJI, Tokyo (JP)

(21) Appl. No.: 14/854,664

(22) Filed: Sep. 15, 2015

(30) Foreign Application Priority Data
Sep. 16, 2014 (JP) 2014-187175

(51) Int. Cl. G06F 11/07; G06F 11/30; G06F 11/34; H04L 12/26

(52) U.S. Cl. CPC G06F 11/079; H04L 43/0829; G06F 11/0709; G06F 11/0751; G06F 11/3006; G06F 11/3466

(57) ABSTRACT

A network processing tracing device includes a network processing unit which carries out network processing on a packet received via a network, an error detection unit which detects occurrence of an error in the network processing, a trace processing unit which acquires, when occurrence of the error is detected by the error detection unit, the packet being processed by the network processing in which occurrence of the error is detected, and trace information being used in the network processing, and an associating unit which associates the packet acquired by the trace processing unit, and the trace information acquired together with the packet with each other.

This application is based upon and claims the benefit of priority from Japanese Patent Application No. 2014-187175, filed on Sep. 16, 2014, the disclosure of which is incorporated herein in its entirety by reference.

### TECHNICAL FIELD

The present invention relates to a technique for tracing network processing.

### BACKGROUND ART

When an error occurs in network processing of an operating system, in many cases, a packet or packets may be dropped (lost). Loss of packets may affect communication of upper layer applications. In view of the above, it is necessary to detect in which processing, a packet has been dropped. There is known a technique for carrying out detailed analysis of network processing by using a trace tool.

General network trace is performed by determining the network processing to be traced in advance, and tracing a packet that has undergone the processing. In this case, not only error processing but also normal processing are traced. Therefore, it is difficult to know in which processing, a packet has been dropped. Further, trace information including normal processing and error processing is output, which may enormously increase the amount of output information.

In view of the above, it is conceivable to perform dynamic trace in which trace processing is carried out by hooking arbitrary error processing. In this case, it is possible to specify the error processing in which a packet has been dropped. However, it is difficult to know which packet has been dropped. This is because it is difficult to associate trace data representing processing which has undergone the error processing, and a dropped packet with each other.

There are known some related arts referring to the aforementioned problems, as described in PTL 1 to PTL 3. For instance, the related art described in PTL 1 associates trace data and a packet with each other by a timestamp. Specifically, the related art described in PTL 1 discloses providing a data acquisition time to trace data as a timestamp, and providing a packet receiving time to a packet as a timestamp. The related art discloses storing in association with the packet, trace data with timestamps within a predetermined range before and after the timestamp of the packet.

### CITATION LIST

### Patent Literature

[PTL 1] Japanese Laid-open Patent Publication No. 2010-154475

[PTL 2] Japanese Laid-open Patent Publication No. 2014-041419

[PTL 3] Japanese Laid-open Patent Publication No. 2013-196377

The related art described in PTL 1 associates trace data and a packet with each other by using timestamps. However, the association precision may be poor with use of only the timestamps. This is because in network processing of an operating system, a plurality of processes are carried out in a certain order with respect to one packet. Therefore, it is difficult to precisely associate trace data in each processing and a target packet with each other only by association by using timestamps.

### SUMMARY

An exemplary object of the invention is to provide a technique capable of associating a packet in which an error has occurred, and trace information with each other more precisely for analysis in tracing network processing.

A network processing tracing device according to an exemplary aspect of the invention includes a network processing unit which carries out network processing on a packet received via a network, an error detection unit which detects occurrence of an error in the network processing, a trace processing unit which acquires, when occurrence of the error is detected by the error detection unit, the packet being processed by the network processing in which occurrence of the error is detected, and trace information being used in the network processing, and an associating unit which associates the packet acquired by the trace processing unit, and the trace information acquired together with the packet with each other.

A network processing tracing system according to another exemplary aspect of the invention includes the above-mentioned network processing tracing device and an analysis device which analyzes the packet and the trace information that are associated with each other by the network processing tracing device.

A network processing tracing method according to another aspect of the invention includes, when occurrence of an error is detected in network processing to be carried out on a packet received via a network, acquiring the packet being processed by the network processing in which occurrence of the error is detected, and trace information being used in the network processing, and associating the acquired packet, and the trace information acquired together with the packet with each other.

A computer-readable storage medium recorded with a program according to another aspect of the invention, which causes a computer to execute a method. The method includes: detecting occurrence of an error in network processing to be carried out on a packet received via a network, acquiring, when occurrence of the error is detected in the detecting, the packet being processed by the network processing in which occurrence of the error is detected, and trace information being used in the network processing, and associating the packet acquired in the acquiring and the trace information acquired together with the packet with each other.

The present invention can provide a technique capable of associating a packet in which an error has occurred, and trace information with each other more precisely for analysis in tracing network processing.

### BRIEF DESCRIPTION OF THE DRAWINGS

Exemplary features and advantages of the present invention will become apparent from the following detailed description when taken with the accompanying drawings in which:

FIG. 1 is a functional block diagram illustrating a network processing tracing system as a first exemplary embodiment of the invention;

FIG. 2 is a diagram illustrating an example of the hardware configuration of the network processing tracing system as the first exemplary embodiment of the invention;

FIG. 3 is a schematic diagram illustrating an example of the configuration of a trace information added packet in the first exemplary embodiment of the invention;

FIG. 4 is a flowchart illustrating an operation to be performed by the network processing tracing system as the first exemplary embodiment of the invention;

FIG. 5 is a functional block diagram illustrating a network processing tracing system as a second exemplary embodiment of the invention;

FIG. 6 is a schematic diagram illustrating an example of the configuration of a trace information added packet in the second exemplary embodiment of the invention;

FIG. 7 is a flowchart illustrating an operation to be performed by the network processing tracing system as the second exemplary embodiment of the invention;

FIG. 8 is a functional block diagram illustrating a network processing tracing system as a third exemplary embodiment of the invention;

FIG. 9 is a flowchart illustrating an operation to be performed by the network processing tracing system as the third exemplary embodiment of the invention;

FIG. 10 is a functional block diagram illustrating a network processing tracing system as a fourth exemplary embodiment of the invention; and

FIG. 11 is a flowchart illustrating an operation to be performed by the network processing tracing system as the fourth exemplary embodiment of the invention.

### EXEMPLARY EMBODIMENT

In the following, exemplary embodiments of the invention are described in detail referring to the drawings.

### First Exemplary Embodiment

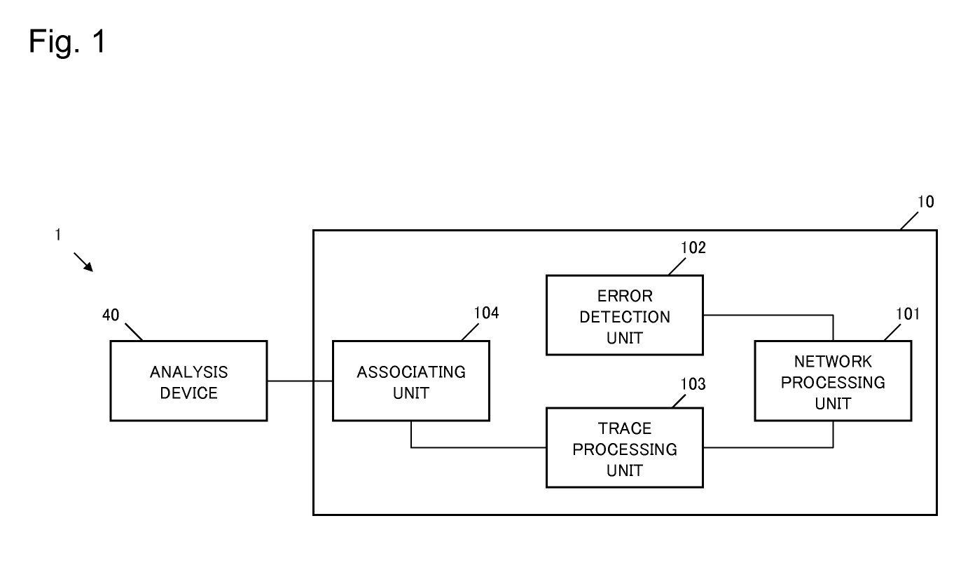

FIG. 1 illustrates the configuration of a network processing tracing system 1 as the first exemplary embodiment of the invention. In FIG. 1, the network processing tracing system 1 is provided with a network processing tracing device 10 and an analysis device 40.

The network processing tracing device 10 is provided with a network processing unit 101, an error detection unit 102, a trace processing unit 103, and an associating unit 104.

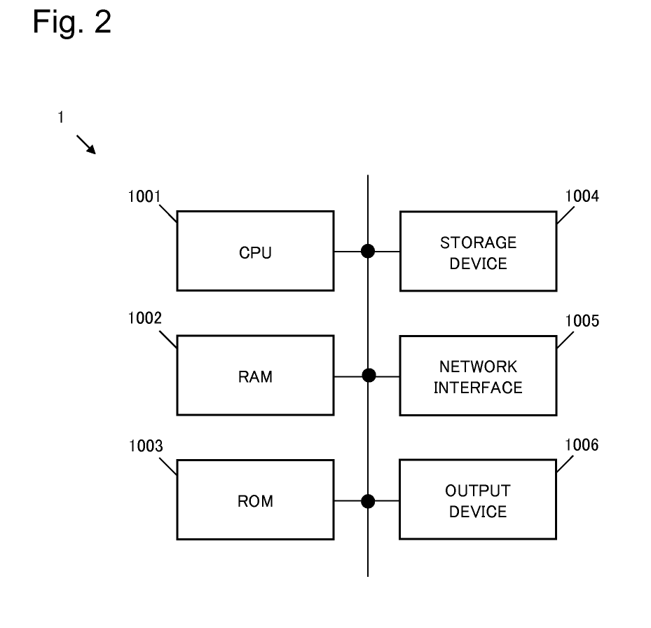

As illustrated in FIG. 2, the network processing tracing system 1 is configurable by a computer device provided with a CPU (Central Processing Unit) 1001, an RAM (Random Access Memory) 1002, an ROM (Read Only Memory) 1003, a storage device 1004 such as a hard disk, a network interface 1005, and an output device 1006. In this case, the network processing unit 101 is constituted by the network interface 1005, and the CPU 1001 that reads out and executes computer programs stored in the ROM 1003 and in the storage device 1004 and various kinds of data onto the RAM 1002. The error detection unit 102, the trace processing unit 103, and the associating unit 104 are constituted by the CPU 1001 that reads out and executes computer programs stored in the ROM 1003 and in the storage device 1004 and various kinds of data onto the RAM 1002. The analysis device 40 is constituted by the output device 1006, and the CPU 1001 that reads out and executes computer programs stored in the ROM 1003 and in the storage device 1004 and various kinds of data onto the RAM 1002. Note that each of the devices constituting the network processing tracing system 1, and the hardware configuration of each of the functional blocks thereof are not limited to the aforementioned configuration. For instance, the analysis device 40 and the network processing tracing device 10 may be individually provided with a CPU, and an ROM that stores programs. Further, the output device 1006 may be provided only in the analysis device 40.

The network processing unit 101 carries out network processing on a packet received via the network interface 1005. A packet may be, for instance, an Ethernet (registered trademark) frame including a TCP (Transmission Control Protocol)/IP (Internet Protocol) packet. Further, in this case, network processing may include various kinds of TCP/IP protocol processing in an operating system. Further, the network processing unit 101 carries out processing while storing, in the RAM 1002 or referring to, raw data in a packet being processed or various kinds of information (such as an internal variable) to be used in the processing.

The error detection unit 102 detects occurrence of an error in network processing. For instance, the error detection unit 102 may use a dynamic patch that instructs to carry out predetermined processing in response to a request for the processing in which a hook is inserted. In this case, the error detection unit 102 inserts a hook in the error processing in network processing from which an error is to be detected. The error detection unit 102 may instruct to operate the trace processing unit 103 to be described later when the error processing in which a hook is inserted is requested by the network processing unit 101.

An example of network processing from which an error is to be detected is a TCP receiving processing function (tcp_v4_rcv). This function carries out TCP protocol processing among the packet receiving processing. Further, this function carries out error processing of checking predetermined items, and of dropping a packet at the time of occurrence of an error. The items to be checked may include checking as to whether the value of a TCP header in a packet is incorrect, and checking as to whether a socket receive buffer has a vacancy for storing a packet. For instance, the error detection unit 102 may insert a hook in error processing of the TCP receiving processing function, and may instruct to operate the trace processing unit 103 when the error processing is carried out by the network processing unit 101.

When occurrence of an error is detected by the error detection unit 102, the trace processing unit 103 acquires a packet being processed in the network processing in which occurrence of the error is detected, and information (trace information) being used in the network processing. In this example, the trace information is an internal variable or the like of the operating system. It is assumed that information to be acquired as trace information is determined in advance. Specifically, the trace processing unit 103 may acquire these information items from the area of the RAM 1002 being used by the network processing unit 101.

For instance, when error processing of the aforementioned TCP receiving processing function (tcp_v4_rcv) is carried out, the trace processing unit 103 may acquire raw data of a packet and the following information items, as trace information:

(i) the amount of holding data in a socket receive buffer;

(ii) the upper limit of a socket receive buffer;

(iii) the amount of socket backlog (area where packets are temporarily held); and

(iv) exclusive information about a socket buffer (whether exclusion is acquired by another processing).

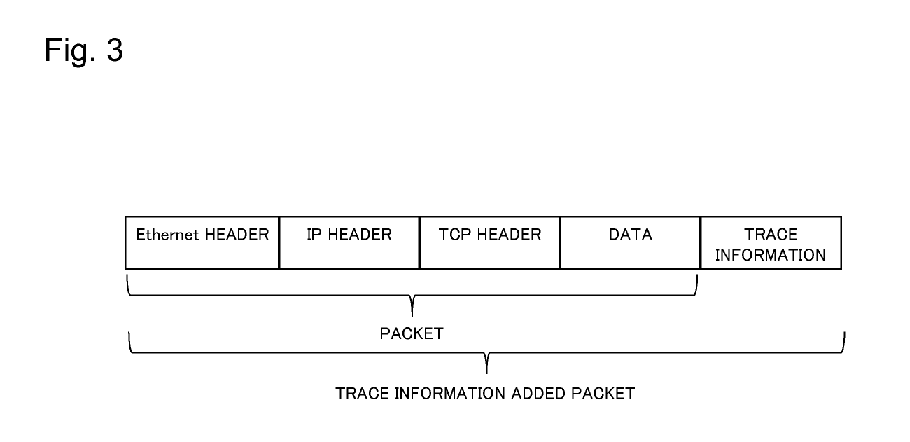

The associating unit 104 associates a packet acquired by the trace processing unit 103, and trace information acquired together with the packet with each other. For instance, the associating unit 104 may generate a trace information added packet, which is obtained by adding, to a packet acquired by the trace processing unit 103, trace information acquired together with the packet. Specifically, the associating unit 104 may add trace information to the data portion of a packet. Further alternatively, the associating unit 104 may modify various kinds of information included in the header portion of a packet, as trace information is added to the data portion. For instance, the associating unit 104 may modify the packet size or a checksum included in the header. For instance, as described above, when the packet is an Ethernet frame including a TCP/IP packet, the trace information added packet is configured as illustrated in FIG. 3.

The analysis device 40 analyzes the packet and the trace information that are associated with each other by the associating unit 104. When the aforementioned trace information added packet has been generated by the associating unit 104, the analysis device 40 may analyze the trace information added packet. In this case, various kinds of well-known techniques are applicable to the packet analysis technique. The analysis device 40 may output an analysis result of the trace information added packet to the output device 1006.

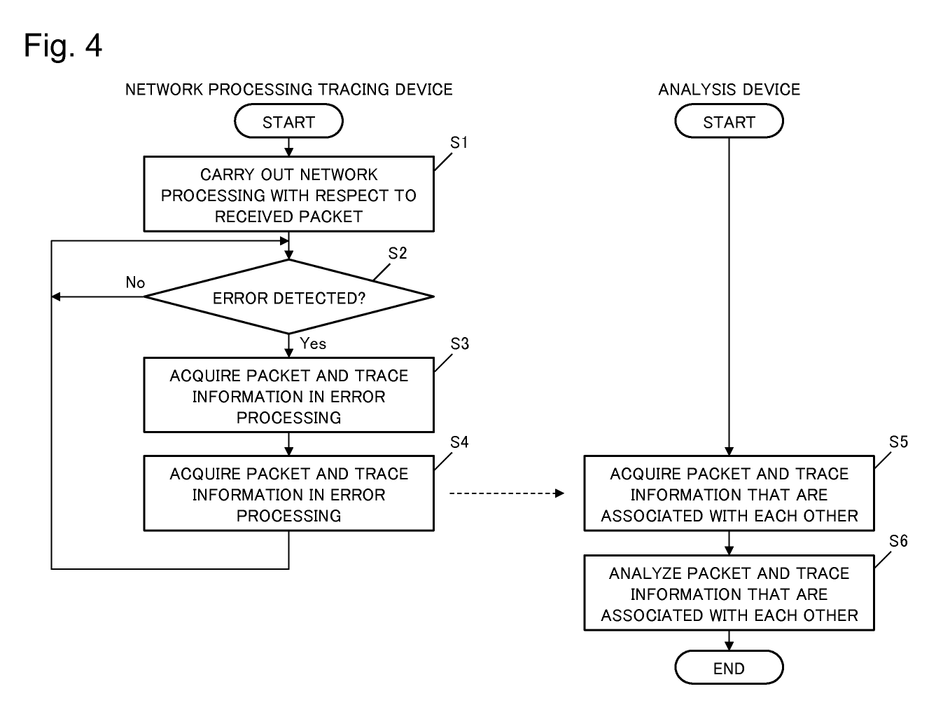

An operation to be performed by the network processing tracing system 1 having the aforementioned configuration is described referring to FIG. 4. In FIG. 4, the left portion indicates an operation to be performed by the network processing tracing device 10, the right portion indicates an operation to be performed by the analysis device 40, and the broken-line arrows joining the left portion and the right portion represents a flow of data.

First of all, in the network processing tracing device 10, the network processing unit 101 carries out network processing on packets sequentially received via the network interface 1005 (Step S1).

Subsequently, when the error detection unit 102 detects occurrence of an error in network processing (Yes in Step S2), the trace processing unit 103 is activated.

The trace processing unit 103 acquires the packet being processed by the network processing in which occurrence of an error is detected, and information (trace information) being used in the network processing (Step S3).

The associating unit 104 associates the packet acquired by the trace processing unit 103, and the trace information acquired together with the packet with each other (Step S4). For instance, as described above, the associating unit 104 may generate a trace information added packet, which is obtained by adding the trace information to the packet. The network processing tracing device 10 repeats the operations from Step S2.

The analysis device 40 acquires the packet and the trace information that are associated with each other in Step S4 (Step S5). For instance, when a trace information added packet is generated in Step S4, the analysis device 40 acquires the trace information added packet.

Subsequently, the analysis device 40 analyzes the packet and the trace information that are associated with each other and acquired in Step S5, and outputs the analysis result (Step S6). For instance, when a trace information added packet has been acquired in Step S5, the analysis device 40 may analyze the trace information added packet.

In this way, the operation of the network processing tracing system 1 is terminated.

Next, the advantageous effects of the first exemplary embodiment of the invention are described.

The network processing tracing system 1 as the first exemplary embodiment of the invention can associate a packet in which an error has occurred and trace information with each other more precisely for analysis in tracing network processing.

This is because the network processing unit 101 carries out network processing with respect to a packet received via a network, and the error detection unit 102 detects occurrence of an error in the network processing. Further, this is because the trace processing unit 103 acquires the packet being processed by the network processing in which occurrence of the error is detected, and information (trace information) being used in the network processing. Furthermore, this is because the associating unit 104 associates the acquired packet and trace information with each other, and the analysis device analyzes the packet and the trace information that are associated with each other.

As described above, in the exemplary embodiment, trace processing is carried out at the time of occurrence of an error in network processing. Therefore, this is advantageous in letting the user know in which processing, a packet has been dropped, and in suppressing an increase in the amount of output information. In addition, in the exemplary embodiment, a packet associated with trace information is analyzed and output by the analysis device 40. This is advantageous in analyzing trace information by a user, while accurately associating a packet and the trace information at the time of occurrence of an error with each other.

Note that the exemplary embodiment is described mainly according to an example, in which a packet and trace information at the time of occurrence of an error are associated with each other by causing the associating unit 104 to generate a trace information added packet. Alternatively, the associating unit 104 may associate a target packet and trace information with each other, using another information capable of representing a correlation between the target packet and the trace information, in place of generating a trace information added packet.

### Second Exemplary Embodiment

Next, the second exemplary embodiment of the invention is described in detail referring to the drawings. In each of the drawings to be referred to in the description of the exemplary embodiment, the same constituent elements and the same steps as those in the first exemplary embodiment of the invention are indicated with the same reference signs, and detailed description thereof in the exemplary embodiment is omitted.

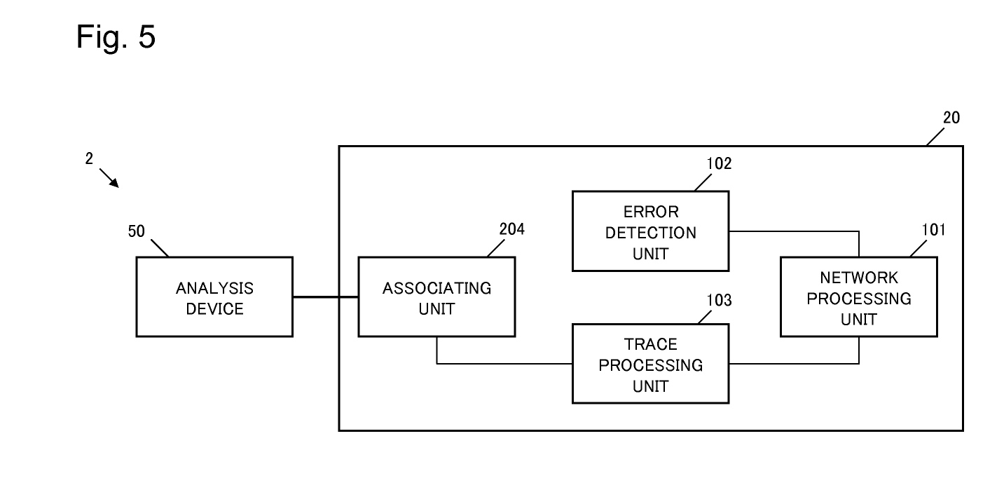

FIG. 5 illustrates the configuration of a network processing tracing system 2 as the second exemplary embodiment of the invention. In FIG. 5, the network processing tracing system 2 includes a network processing tracing device 20 and an analysis device 50. The network processing tracing device 20 is different from the network processing tracing device 10 as the first exemplary embodiment of the invention in that the network processing tracing device 20 is provided with an associating unit 204, in place of the associating unit 104.

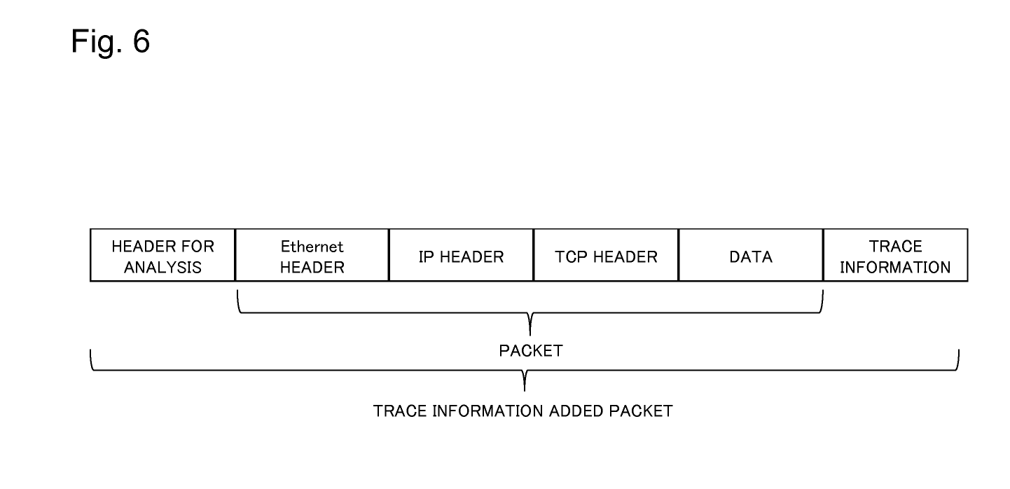

The associating unit 204 adds a header for analysis to the head of a target packet, in addition to adding trace information to the data portion of the target packet. This is because the analysis device 50 to be described later is configured to read out information including a predetermined header for analysis as information to be analyzed. FIG. 6 illustrates an example of a trace information added packet to be generated by the associating unit 204. The associating unit 204 may output, to a storage device 1004, a trace information added packet including a header for analysis, and may store the trace information added packet as a file.

The analysis device 50 is configured to read out information including a predetermined header for analysis as information to be analyzed. The analysis device 50 reads out and analyzes the trace information added packet in which the header for analysis is added. For instance, the analysis device 50 may be constituted by a packet capturing tool employing pcap (packet capturing) technique. Examples of the packet capturing tool are tcpdump and wireshark. In this case, the analysis device 50 is capable of reading out and analyzing data in the format of pcap including a pcap header from the storage device 1004, in addition to capturing and analyzing a packet flowing through a network. In this case, the associating unit 204 may add the pcap header to the head of the packet.

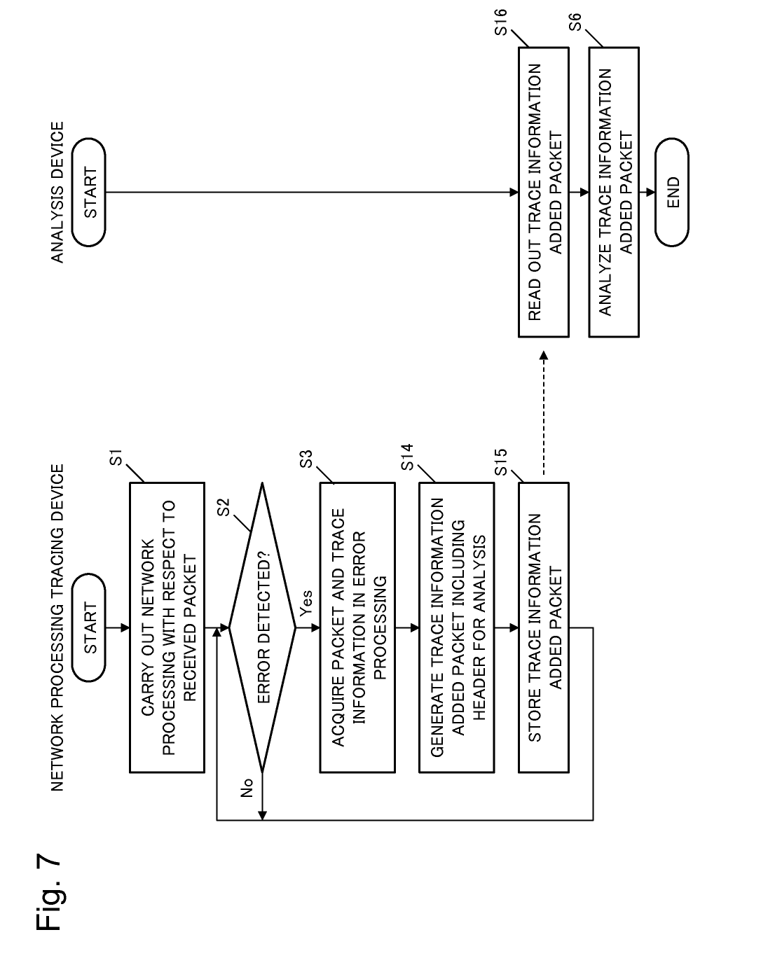

An operation to be performed by the network processing tracing system 2 having the aforementioned configuration is described referring to FIG. 7.

In FIG. 7, the network processing tracing device 20 is operated in the same manner as in the first exemplary embodiment of the invention in Step S1 to Step S3. The network processing tracing device 20 acquires a packet being processed in network processing in which occurrence of an error is detected, and trace information being used in the network processing.

Subsequently, the associating unit 204 generates a trace information added packet, which is obtained by adding, to a packet acquired by a trace processing unit 103, trace information acquired together with the packet, and a header for analysis (Step S14).

Subsequently, the associating unit 204 outputs the trace information added packet to the storage device 1004, and stores the trace information added packet as a file (Step S15).

The analysis device 50 reads out the trace information added packet including the header for analysis, which is stored in Step S15 (Step S16).

Subsequently, the analysis device 50 analyzes the readout trace information added packet, and outputs the analysis result by executing Step S6 in the same manner as in the first exemplary embodiment of the invention.

In this way, the operation of the network processing tracing system 2 is terminated.

Next, the advantageous effects of the second exemplary embodiment of the invention are described.

The network processing tracing system 2 as the second exemplary embodiment of the invention is capable of easily analyzing information, in which a packet in which an error has occurred and trace information are associated with each other more precisely in tracing network processing.

This is because the associating unit 204 generates a trace information added packet, which is obtained by adding trace information and a header for analysis to the acquired packet, and the analysis device 50 reads out and analyzes the trace information added packet including the header for analysis, in addition to the same configuration as in the first exemplary embodiment of the invention.

In this way, in the exemplary embodiment, generating a trace information added packet including a header for analysis makes it possible to read out and analyze the trace information added packet at an intended timing by a general analysis device capable of reading out a packet including a header for analysis. Therefore, the exemplary embodiment makes it easy to analyze information in which a packet and trace information at the time of occurrence of an error are accurately associated with each other, without the need of a dedicated analysis device.

The exemplary embodiment is described by way of an example, in which an analysis device is tcpdump or wireshark employing pcap technique. Alternatively, the analysis device may have any configuration, as far as the analysis device is provided with a function of reading out and analyzing a trace information added packet including a predetermined header for analysis.

### Third Exemplary Embodiment

Next, the third exemplary embodiment of the invention is described in detail referring to the drawings. In each of the drawings to be referred to in the exemplary embodiment, the same constituent elements and the same steps as those in the first exemplary embodiment of the invention are indicated with the same reference signs, and detailed description thereof in the exemplary embodiment is omitted.

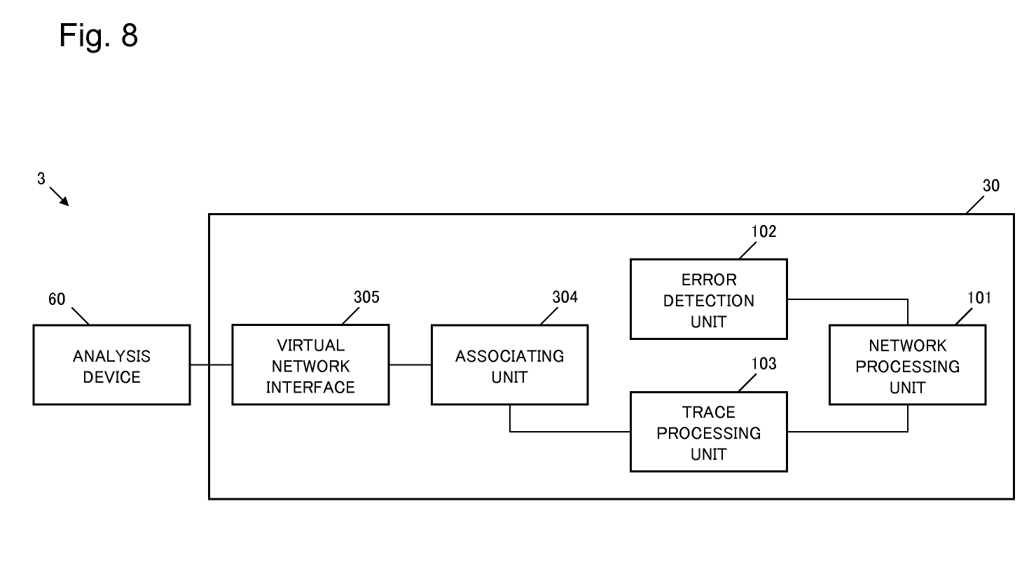

FIG. 8 illustrates the configuration of a network processing tracing system 3 as the third exemplary embodiment of the invention. In FIG. 8, the network processing tracing system 3 includes a network processing tracing device 30 and an analysis device 60. The network processing tracing device 30 is different from the network processing tracing device 10 as the first exemplary embodiment of the invention in that the network processing tracing device 30 is provided with an associating unit 304, in place of the associating unit 104, and is further provided with a virtual network interface 305.

The virtual network interface 305 implements a network interface with a software. The virtual network interface 305 is implementable by a well-known technique for implementing a virtual network interface. The virtual network interface 305 corresponds to an example of a network interface of the invention. Preferably, the virtual network interface 305 is configured to allow a trace information added packet to flow, while keeping a network packet other than the above packet from flowing.

The associating unit 304 generates a trace information added packet, which is obtained by adding trace information to the data portion of a target packet, for example as illustrated in FIG. 3, in the same manner as in the first exemplary embodiment of the invention. Further, the associating unit 304 transmits the generated trace information added packet via the virtual network interface 305. The transmission destination may be the transmission destination of an original packet.

The analysis device 60 is configured to capture and analyze a packet flowing through the virtual network interface 305. For instance, the analysis device 60 is implementable by setting an interface to be analyzed as the virtual network interface 305, using a general packet capturing tool. For instance, as well as the analysis device 50 in the second exemplary embodiment of the invention, the analysis device 60 may be constituted by a packet capturing tool employing pcap technique (such as the aforementioned tcpdump and wireshark). In this case, the analysis device 60 is capable of capturing and analyzing a packet flowing through a network interface to be analyzed. In this way, the analysis device 60 captures and analyzes a trace information added packet.

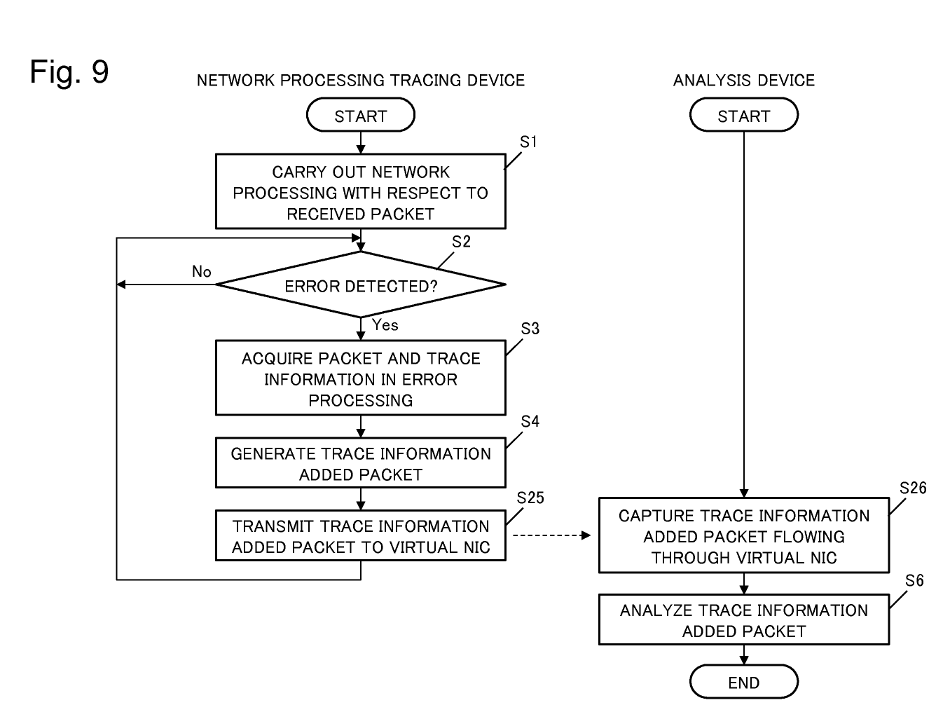

An operation to be performed by the network processing tracing system 3 having the aforementioned configuration is described referring to FIG. 9.

In FIG. 9, the network processing tracing device 30 is operated in the same manner as in the first exemplary embodiment of the invention in Step S1 to Step S4. This makes it possible to generate a trace information added packet, which is obtained by adding, to a packet at the time of occurrence of an error, trace information acquired at the time of occurrence of the error.

Subsequently, the associating unit 304 transmits the trace information added packet generated in Step S4 via the virtual network interface 305 (Step S25).

Subsequently, the analysis device 60 captures the trace information added packet flowing through the virtual network interface 305 (Step S26).

The analysis device 60 analyzes the captured trace information added packet, and outputs the analysis result by executing Step S6 in the same manner as in the first exemplary embodiment of the invention.

After the aforementioned steps, the operation of the network processing tracing system 3 is terminated.

Next, the advantageous effects of the third exemplary embodiment of the invention are described.

The network processing tracing system 3 as the third exemplary embodiment of the invention is capable of easily analyzing information, in which a packet in which occurrence of an error is detected and trace information are associated with each other more precisely in tracing network processing.

This is because the associating unit 304 transmits a generated trace information added packet via a virtual network interface, and the analysis device 60 captures and analyzes the trace information added packet flowing through the virtual network interface, in addition to the same configuration as in the first exemplary embodiment of the invention.

In this way, in the exemplary embodiment, allowing a trace information added packet to flow through a virtual network interface makes it possible to capture and analyze the trace information added packet by a general analysis device capable of capturing a packet flowing through a network interface. Therefore, the exemplary embodiment makes it easy to analyze information in which a packet and trace information at the time of occurrence of an error are accurately associated with each other, without the need of a dedicated analysis device.

The exemplary embodiment is described by way of an example, in which an analysis device is tcpdump or wireshark employing pcap technique. Alternatively, the analysis device may have any configuration, as far as the analysis device is provided with a function of capturing and analyzing a trace information added packet flowing through a network interface for analysis.

### Fourth Exemplary Embodiment

Next, the fourth exemplary embodiment of the invention is described in detail referring to the drawings. In each of the drawings to be referred to in the exemplary embodiment, the same constituent elements and the same steps as those in the third exemplary embodiment of the invention are indicated with the same reference signs, and detailed description thereof in the exemplary embodiment is omitted.

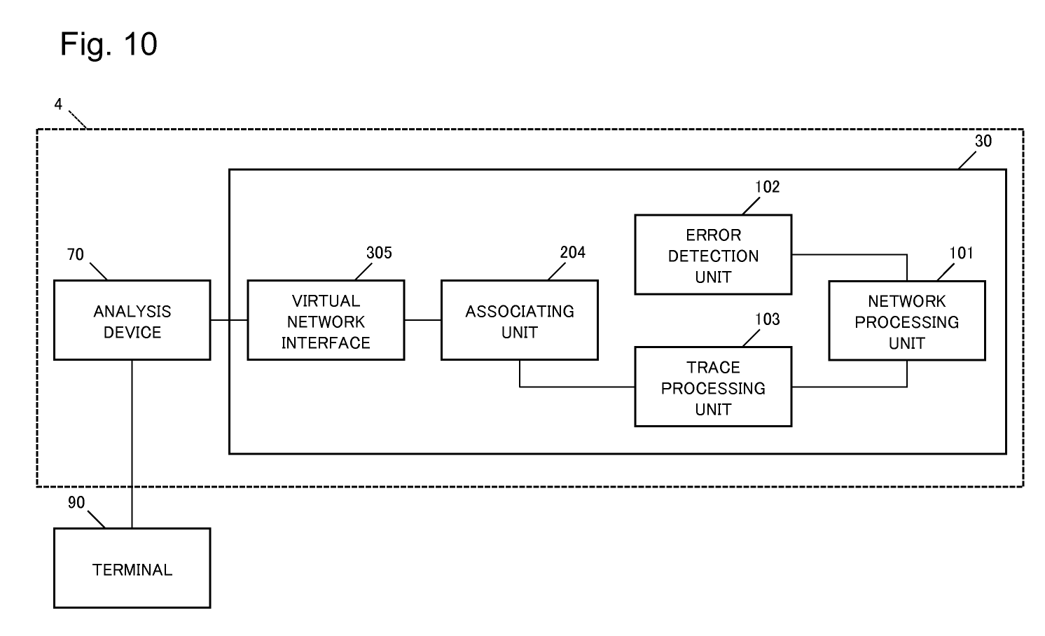

FIG. 10 illustrates the configuration of a network processing tracing system 4 as the fourth exemplary embodiment of the invention. In FIG. 10, the network processing tracing system 4 is different from the network processing tracing system 3 as the third exemplary embodiment of the invention in that the network processing tracing system 4 is provided with an analysis device 70, in place of the analysis device 60. Further, the analysis device 70 is communicatively connected to a terminal 90.

The analysis device 70 includes a function of monitoring a virtual network interface 305, and a function of capturing a trace information added packet flowing through the virtual network interface 305. Further, the analysis device 70 analyzes the trace information added packet to generate analysis information, and transmits the analysis information to the terminal 90 in response to a query from the terminal 90. For instance, the analysis device 70 is implementable by an SNMP (Simple Network Management Protocol) agent provided with a packet capturing function. In this case, the terminal 90 is constituted by an SNMP manager.

Specifically, in this case, the SNMP agent as the analysis device 70 captures a trace information added packet flowing through the virtual network interface 305. The analysis device 70 interprets the trace information added packet, and stores the trace information added packet as MIB (Management Information Base) information that is uniquely defined. The analysis device 70 may transmit MIB information relating to a trace information added packet in response to a query from the terminal 90 as the SNMP manager. For instance, when the trace information added packet represents a packet and trace information at the time of occurrence of an error in a TCP protocol stack, the analysis device 70 may define the number of packets that have been dropped in the TCP protocol stack as the unique MIB information.

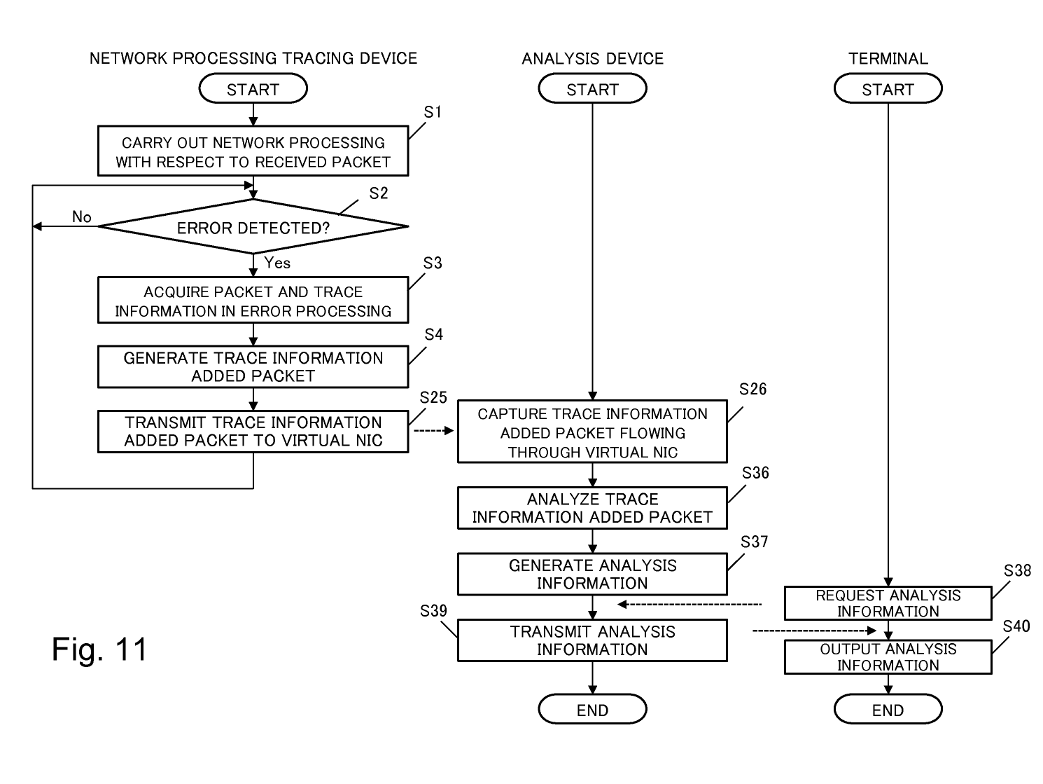

An operation to be performed by the network processing tracing system 4 having the aforementioned configuration is described referring to FIG. 11. In FIG. 11, the left portion indicates an operation to be performed by the network processing tracing device 30, the middle portion indicates an operation to be performed by the analysis device 70, and the right portion indicates an operation to be performed by the terminal 90. In FIG. 11, each of the broken-line arrows represents a flow of data.

In FIG. 11, the network processing tracing device 30 is operated in the same manner as in the third exemplary embodiment of the invention in Step S1 to Step S4, and Step S25. Thus, a trace information added packet, which is obtained by adding, to a packet at the time of occurrence of an error, trace information at the time of occurrence of the error, is transmitted to the virtual network interface 305.

The analysis device 70 captures the trace information added packet flowing through the virtual network interface 305 by executing Step S26 in the same manner as in the second exemplary embodiment of the invention.

Subsequently, the analysis device 70 analyzes the trace information added packet, and generates analysis information (Step S37).

Subsequently, the terminal 90 transmits, to the analysis device 70, a request to transmit analysis information (Step S38).

The analysis device 70 transmits the analysis information generated in Step S37 to the terminal 90 (Step S39).

Subsequently, the terminal 90 outputs the received analysis information (Step S40).

In this way, the operation of the network processing tracing system 4 is terminated.

Next, the advantageous effects of the fourth exemplary embodiment of the invention are described.

The network processing tracing system 4 as the fourth exemplary embodiment of the invention is capable of monitoring, from another device, analysis information, in which a packet in which occurrence of an error is detected and trace information are associated with each other more precisely in tracing network processing.

This is because the analysis device 70 captures a trace information added packet that is generated by the network processing tracing device 30 configured in the same manner as in the third exemplary embodiment of the invention and that flows through a virtual network interface to generate analysis information, and transmits the analysis information in response to a query from a terminal.

As described above, in the exemplary embodiment, causing an analysis device capable of monitoring a network and transmitting monitoring information in response to a query from a terminal to capture a trace information added packet makes it possible to browse analysis information representing a result of accurately associating a packet and trace information at the time of occurrence of an error with each other through an external terminal.

Note that the exemplary embodiment is described mainly according to an example, in which the analysis device is an SNMP agent. Alternatively, the analysis device may have any configuration, as far as the analysis device is provided with a function of capturing and analyzing a trace information added packet flowing through a virtual network interface, and a function of notifying analysis information to an external device.

The third and fourth exemplary embodiments of the invention are described by way of an example, in which a virtual network interface is applied as the network interface of the invention. However, the exemplary embodiments are not limited thereto, and the network interface of the invention may be constituted by a physical network interface, as far as the network interface is a network interface usable in order to allow a trace information added packet to flow.

Each of the exemplary embodiments of the invention is described mainly according to an example, in which the error detection unit 102 detects occurrence of an error by a dynamic patch. Alternatively, the error detection unit 102 in each of the exemplary embodiments may be implemented by another configuration capable of detecting occurrence of an error in network processing.

Each of the exemplary embodiments of the invention is described mainly according to an example, in which a target packet is an Ethernet frame including a TCP/IP packet, and network processing is various kinds of TCP/IP protocol processing. However, the exemplary embodiments are not limited thereto, and in the invention, a target packet may include data based on another protocol, and network processing may be protocol processing other than the above.

Each of the exemplary embodiments of the invention is described mainly according to an example, in which the network processing tracing device 10, 20, or 30; and the analysis device 40, 50, 60, or 70 are implemented on one computer. Alternatively, these devices may be configured by computers different from each other.

Each of the exemplary embodiments of the invention is described mainly according to an example, in which each of the functional blocks of the network processing tracing system 1, 2, 3, or 4 is implemented by a CPU that executes a computer program stored in a storage device or in an ROM. Alternatively, a part, or all, or combination of the functional blocks may be implemented by a dedicated hardware.

In each of the exemplary embodiments of the invention, the functional blocks of the network processing tracing device may be distributed and implemented by a plurality of devices.

In each of the exemplary embodiments of the invention, the operation of each of the devices, which is described referring to each of the flowcharts, may be recorded as a computer program of the invention. The computer program may be stored in a storage device (storage medium) of a computer. In this case, the computer program may be read out and executed by the CPU. In this case, the invention is constituted by codes of the computer program, or is constituted by a storage medium.

Each of the exemplary embodiments may be implemented by combining the exemplary embodiments, as necessary.

The invention is not limited to the aforementioned exemplary embodiments, but may be carried out by a variety of modifications.

[Reference signs List]

| | |
|---|---|
| 1, 2, 3, 4 | Network processing tracing system |
| 10, 20, 30 | Network processing tracing device |
| 40, 50, 60, 70 | Analysis device |
| 90 | Terminal |
| 101 | Network processing unit |
| 102 | Error detection unit |
| 103 | Trace processing unit |
| 104, 204, 304 | Associating unit |
| 305 | Virtual network interface |
| 1001 | CPU |
| 1002 | RAM |
| 1003 | ROM |
| 1004 | Storage device |
| 1005 | Network interface |
| 1006 | Output device |

1. A network processing tracing device comprising:
a network processing unit which carries out network processing on a packet received via a network;
an error detection unit which detects occurrence of an error in the network processing;
a trace processing unit which acquires, when occurrence of the error is detected by the error detection unit, the packet being processed by the network processing in which occurrence of the error is detected, and trace information being used in the network processing; and
an associating unit which associates the packet acquired by the trace processing unit, and the trace information acquired together with the packet with each other.

2. The network processing tracing device according to claim 1, wherein
the associating unit generates a packet, the packet being obtained by adding, to the packet acquired by the trace processing unit, the trace information acquired together with the packet.

3. The network processing tracing device according to claim 2, further comprising:
a network interface through which the generated packet is allowed to flow, wherein
the associating unit transmits the generated packet via the network interface.

4. The network processing tracing device according to claim 2, wherein
the associating unit adds a header for analysis to the generated packet.

5. A network processing tracing system comprising:
work processing tracing device according to claim 1; and
an analysis device which analyzes the packet and the trace information that are associated with each other by the network processing tracing device.

6. The network processing tracing system according to claim 5, further comprising:
a network interface through which a packet is allowed to flow, wherein
the associating unit generates a packet and transmits the generated packet via the network interface, the packet being obtained by adding, to the packet acquired by the trace processing unit, the trace information acquired together with the packet, and
the analysis device captures the generated packet flowing through the network interface, and analyzes the trace information.

7. The network processing tracing system according to claim 5, further comprising:
a network interface through which the generated packet is allowed to flow, wherein
the associating unit adds a header for analysis to the generated packet, and
the analysis device reads out the packet including the header for analysis, and analyzes the trace information.

8. A network processing tracing method comprising:
when occurrence of an error is detected in network processing to be carried out on a packet received via a network,
acquiring the packet being processed by the network processing in which occurrence of the error is detected, and trace information being used in the network processing; and
associating the acquired packet, and the trace information acquired together with the packet with each other.

9. A computer-readable storage medium recorded with a program which causes a computer to execute a method, the method comprising:
detecting occurrence of an error in network processing to be carried out on a packet received via a network;
acquiring, when occurrence of the error is detected in the detecting, the packet being processed by the network processing in which occurrence of the error is detected, and trace information being used in the network processing; and
associating the packet acquired in the acquiring and the trace information acquired together with the packet with each other.
